(19) United States
(12) Patent Application Publication
(10) Pub. No.: US 2006/0211450 A1
(43) Pub. Date: Sep. 21, 2006

(54) Method and apparatus for controlling push-to-talk functions of a mobile communication unit from a unit circuit card

(76) Inventors: Sabine van Niekerk, Salzgitter-Lebenstedt (DE); Norbert Schwagmann, Lehe (DE)

Correspondence Address: EDELL, SHAPIRO & FINNAN, LLC, 1901 RESEARCH BOULEVARD, SUITE 400, ROCKVILLE, MD, 20850, US

(21) Appl. No.: 11/083,137

(22) Filed: Mar. 18, 2005

(51) Int. Cl. H04B 7/00

(52) U.S. Cl. 455/558; 455/518

(57) ABSTRACT

A method and apparatus according to the present invention enable a circuit card of a mobile communication unit to control Push-to-Talk features of a mobile terminal within that unit. The circuit card controls initiation and termination of a Push-to-Talk session for the mobile terminal, thereby enabling a communication network operator to define and develop applications on the circuit card that utilize the Push-to-Talk features.

### BACKGROUND OF THE INVENTION

1. Technical Field

The present invention pertains to mobile communication systems with Push-to-Talk capability between mobile communication units. In particular, the present invention pertains to control of Push-to-Talk functions of a mobile communication unit from a circuit card within that unit.

2. Discussion of the Related Art

Mobile communication systems or networks (e.g., Universal Mobile Telecommunications System (UMTS)) include mobile communication or telephone units that enable users to communicate. The mobile communication units of UMTS each generally include a mobile communication device or terminal (e.g., mobile telephone, etc.) and a circuit card in the form of a smart card or Universal Integrated Circuit Card (UICC) to interface the mobile terminal and enable a user to utilize a mobile communication or telephone service in accordance with a user subscription. The circuit card typically includes user preferences, settings and/or personal information. For example, the circuit card may include a subscriber identity module (e.g., UMTS Subscriber Identity Module (USIM)) that stores data for identifying a caller to a UMTS network service provider and for encrypting voice and data transmissions. The subscriber identity module may further store telephone numbers and corresponding names.

Push-to-Talk is a mobile communication service based on a two-way form of communications allowing a user to engage in immediate communication with one or more other users without the formalities of conventional calls. The Push-to-Talk service is similar in operation to two-way radios commonly referred to as “Walkie-Talkies”. In particular, when a user desires to speak, a button on a user handset or mobile terminal is depressed. This enables the user to speak, while another user receives the transmission and hears the sender voice signals automatically without answering a call. The Push-to-Talk service is a cost efficient and user friendly direct voice service.

The Push-to-Talk service employs floor control and group types. Floor control is a mechanism to ensure that only one user within a Push-to-Talk session has the right (and, therefore, is able) to speak. When a user desires the right to speak, a floor request message is transmitted from the user communication unit to a Push-to-Talk server of the communication system in order to gain access to the floor or the right to speak. The Push-to-Talk server determines the particular user to receive access to the floor and transmits a floor grant message to that user, while other users requesting access to the floor receive a floor reject message. Once the user with floor access completes speaking, a floor release message is transmitted from the user communication unit to the Push-to-Talk server to enable the server to grant new floor requests.

The Push-to-Talk service accommodates addressing of user groups. One type of group is a pre-arranged group (e.g., a group with predetermined members). If a first user establishes a Push-to-Talk session with a pre-arranged group, all members of this group are invited to join this session and the first user or initiator automatically receives the right to the floor (e.g., receives a floor grant message from the Push-to-Talk server without explicitly sending a floor request). Another type of group is a chat group (e.g., a dynamically formed group of users desiring to communicate). If a user establishes a Push-to-Talk session with the Push-to-Talk server in order to join a chat group session, users are not automatically invited to join this session. Rather, the user communicates with users currently participating in the chat group session. A user within a Push-to-Talk chat group session has to request the right to speak by sending a floor request to the Push-to-Talk server.

Operators of the communication network may define operator-specific applications on the circuit card of the mobile communication unit to perform operator-specified functions. The applications utilize an application toolkit (e.g., USIM Application Toolkit (USAT)) to enable performance of and control specific mobile terminal functions (e.g., sending a Short Message Service (SMS) message to the communication network, playing a tone on a mobile terminal, displaying text or an icon on the display of the mobile terminal, etc.). The application toolkit serves as a standardized interface between the circuit card and the mobile communication terminal of the mobile communication unit.

The toolkit provides communication network operators with a standardized Application Programming Interface (API) to enable placement of operator-specific applications on the circuit card independent of the particular operator, smart card manufacturer and mobile terminal manufacturer. The toolkit further provides a standardized execution environment for applications stored on the circuit card and/or subscriber identity module and the ability for the circuit card to utilize certain functions of the supporting mobile terminal (e.g., mobile telephone). The toolkit includes mechanisms to allow applications residing on the circuit card and/or subscriber identity module to interact with and operate any mobile terminal that supports these mechanisms, thereby ensuring interoperability between a circuit card and mobile terminal independent of the respective manufacturers and operators. The circuit card is the physical basis for the toolkit since the circuit card is owned by the communication network operator and may be adapted to the operator needs. For examples of toolkits, reference is made to: “3^{rd} Generation Partnership Project; Technical Specification Group Terminals; USIM Application Toolkit (USAT) (Release 6)”, 3GPP TS 31.111, v6.2.0, June 2004; and “Smart cards; Card Application Toolkit (CAT) (Release 6)”, ETSI TS 102 223, v6.5.0, June 2004. The disclosures of these documents are incorporated herein by reference in their entireties.

However, there are currently no provisions for communication network operators to define applications on the circuit card that use the Push-to-Talk functionality of the mobile terminal. This severely limits the mobile terminal to specific pre-defined functions, reducing the ability of the mobile terminal to satisfy varying user needs.

### SUMMARY OF THE INVENTION

According to the present invention, a method and apparatus enable a circuit card of a mobile communication unit to control Push-to-Talk features of a mobile terminal within that unit. The circuit card controls initiation and termination of a Push-to-Talk session for the mobile terminal, thereby enabling a communication network operator to define and develop applications on the circuit card that utilize the Push-to-Talk features.

The above and still further features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1A is a diagrammatic illustration of an exemplary mobile communication system or network employing a mobile communication unit with applications defined by a communication network operator to control Push-to-Talk functions according to the present invention.

FIG. 1B is a block diagram of an exemplary circuit card of a mobile communication unit of the system of FIG. 1A.

FIG. 1C is a block diagram of an exemplary mobile terminal of a mobile communication unit of the system of FIG. 1A.

FIG. 2 is a flow diagram illustrating the manner in which a Push-to-Talk session for a pre-arranged user group is initiated by a circuit card of a mobile communication unit according to the present invention.

FIG. 3 is a flow diagram illustrating an alternative manner in which a Push-to-Talk session for a pre-arranged user group is initiated by a circuit card of a mobile communication unit according to the present invention.

FIG. 4 is a flow diagram illustrating yet another manner in which a Push-to-Talk session for a pre-arranged user group is initiated by a circuit card of a mobile communication unit according to the present invention.

FIG. 5 is a flow diagram illustrating the manner in which a Push-to-Talk session for a user chat group is initiated by a circuit card of a mobile communication unit according to the present invention.

FIG. 6 is a flow diagram illustrating the manner in which a Push-to-Talk session is terminated by a circuit card of a mobile communication unit according to the present invention.

### DETAILED DESCRIPTION OF THE PREFERRED EMBODIMENTS

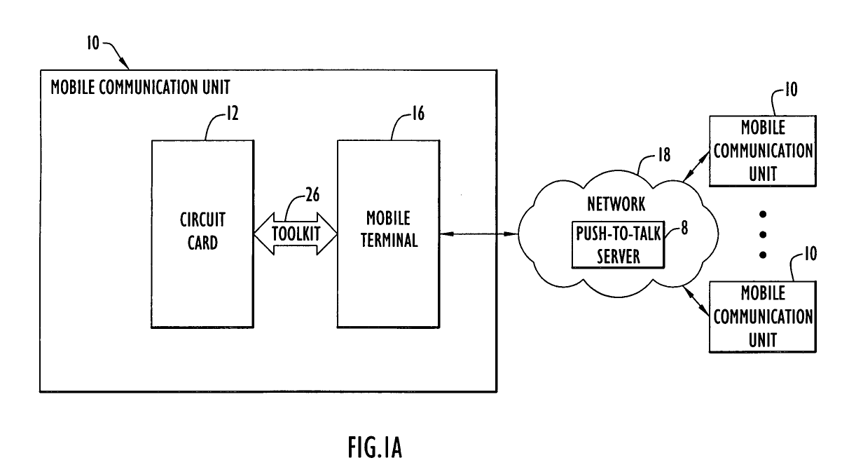

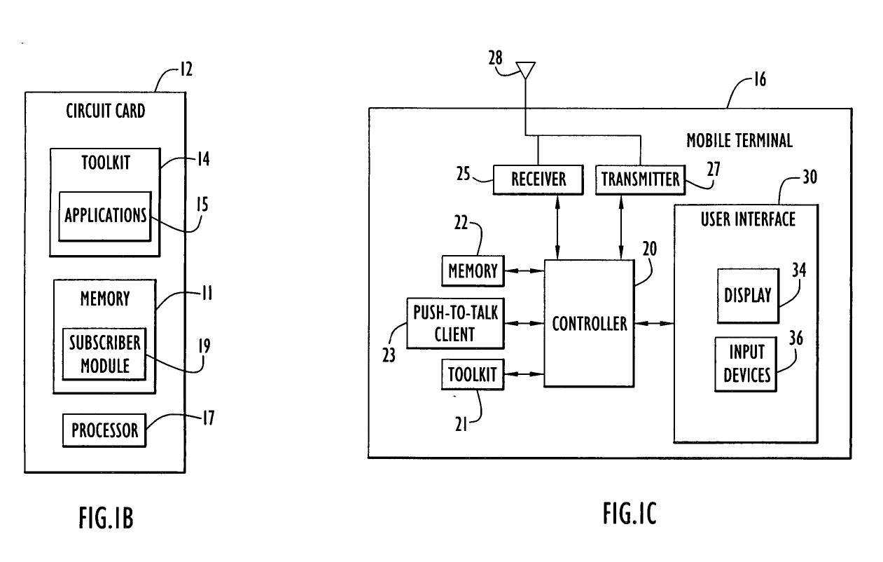

An exemplary mobile communication system or network employing mobile communication or telephone units with Push-to-Talk capability according to the present invention is illustrated in FIGS. 1A-1C. In particular, the communication system includes a plurality of mobile communication units 10 and a communication service network 18 in communication with and to transfer information between the mobile communication units. The communication system is preferably implemented by a Universal Mobile Telecommunications System (UMTS) and supports Push-to-Talk capability; however, the communication system may be implemented by any mobile communication system or network.

Communication service network 18 may be implemented by a conventional communication network and includes various conventional components for transfer of information (e.g., base stations, computer and/or server systems, interfaces to telephone system lines, etc.). The communication service network further includes a Push-to-Talk server system 8 to implement the Push-to-Talk features of the communication system. Push-to-Talk is a communication service based on a two-way form of communications allowing a user or mobile communication unit to engage in immediate communication with one or more other mobile communication units without the formalities of conventional calls. The Push-to-Talk service is similar in operation to two-way radios commonly referred to as “Walkie-Talkies”. Server system 8 is typically implemented by a conventional personal or other suitable computer system and preferably equipped with a base (e.g., including the processor, memories and internal or external communication devices (e.g., modem, network cards, etc.)) and optional display and input devices (e.g., a keyboard or other entry device, a mouse or other input device, etc.). The server system includes software (e.g., operating system, server software, Push-to-Talk software, etc.) to communicate with the mobile communication units and facilitate the Push-to-Talk features of the communication system, and appropriate components (e.g., processor, disk storage or hard drive, communication devices, etc.) having sufficient processing and storage capabilities to effectively execute the server software. The server system may utilize any of the commercially available operating systems, databases and/or server software.

The Push-to-Talk service employs floor control and group types as described above. Floor control is a mechanism to ensure that only one user within a Push-to-Talk session has the right to speak. If a user wants the right to speak, a floor request message is transmitted from the corresponding mobile communication unit to Push-to-Talk server 8 of the communication service network. The user receives a floor grant message from the Push-to-Talk server in response to being granted the right to speak. Once the user completes speaking, a floor release message is transmitted from the corresponding mobile communication unit to Push-to-Talk server 8 to enable the server to grant new floor requests.

The Push-to-Talk service further accommodates addressing of user groups as described above. These groups include pre-arranged groups (e.g., groups with predetermined members) and chat groups (e.g., dynamically formed groups of users desiring to communicate). If a user establishes a Push-to-Talk session for a pre-arranged group, all members of this group are invited to join the session and the first user or initiator automatically receives the right to speak or the floor (e.g., receives a floor grant message from Push-to-Talk server 8 without explicitly sending a floor request). When a user establishes a Push-to-Talk session with Push-to-Talk server 8 in order to join a chat group session, other users are not automatically invited to join this session. Rather, the user communicates with other users within the chat group session. A user who joins a Push-to-Talk chat group session has to request the right to speak by sending a floor request to the Push-to-Talk server.

Mobile communication unit 10 includes a circuit card 12, a mobile terminal 16 and an application interface or toolkit 26. The toolkit serves as an interface between the circuit card and mobile terminal as described below. Circuit card 12 may be in the form of a smart card or Universal Integrated Circuit Card (UICC) to interface mobile terminal 16 and enable a user to utilize a mobile communication service in accordance with a user subscription. The circuit card (FIG. 1B) includes a memory 11, a toolkit module 14 of toolkit 26 and a processor 17. The memory may be implemented by any conventional or other memory device (e.g., RAM, ROM, application memory, etc.) and stores various information (e.g., user preferences, settings and/or personal information, etc.). For example, memory 11 may be in the form of or include a subscriber identity module 19 (e.g., Universal Subscriber Identity Module (USIM)) that stores applications and/or data for identifying a caller to a Universal Mobile Telecommunications System (UMTS) service provider and for encrypting voice and data transmissions. The subscriber identity module may further store operator and user specific parameters and data (e.g., telephone numbers and corresponding names, etc.). Processor 17 may be implemented by any conventional or other controller, microprocessor or circuitry and controls operation of the circuit card (e.g., Push-to-Talk and other communication functions, etc.) in accordance with applications or software stored on the card (e.g., within memory 11 and/or subscriber module 19, within toolkit module 14, etc.). Toolkit module 14 serves as an interface to enable the circuit card to control mobile terminal functionality as described below Mobile terminal 16 (FIG. 1C) is preferably in the form of a conventional mobile device (e.g., mobile telephone, Personal Digital Assistant (PDA), etc.) and includes a controller 20, a toolkit module 21 of toolkit 26, a memory 22, a Push-to-Talk client application 23, a receiver 25, a transmitter 27, an antenna 28 and a user interface 30. Controller 20 may be implemented by any conventional or other controller or microprocessor and controls operation of the mobile terminal (e.g., Push-to-Talk and other communication functions, etc.) in accordance with applications or software stored on the mobile terminal (e.g., Push-to-Talk client 23 for communicating with the Push-to-Talk server and enabling Push-to-Talk service, applications for controlling the user interface, toolkit module 21, etc.). Toolkit module 21 serves as an interface to enable circuit card 12 to control mobile terminal functionality as described below. The controller may further perform various processing of signals (e.g., digital to analog conversion, analog to digital conversion, speech coding, etc.) for transmission to communication service network 18 and/or for conveyance to a user. The controller is coupled to receiver 25 and transmitter 27 that respectively receive and transmit signals with communication service network 18 via antenna 28 in accordance with controller instructions. The receiver and transmitter may be implemented by any conventional or other receiving and/or transmitting devices, while memory 22 may be implemented by any conventional or other memory device (e.g., RAM, ROM, application memory, etc.) and stores various information (e.g., user preferences, settings and/or personal information, applications, etc.).

User interface 30 enables performance of conventional mobile terminal functions (e.g., place and receive calls, Push-to-Talk, etc.) and includes a display 34 and input devices 36. Display 34 may be implemented by any type of display device (e.g., LCD, LED, etc.) and provides information to a user. Input devices 36 enable entry of data or selected functions by a user and may be implemented by any conventional devices (e.g., keypad, buttons, Push-to-Talk button, etc.). The input devices further enable voice signals to be conveyed to or received from a user and may include any conventional voice devices (e.g., microphone, speaker, etc.). The mobile terminal typically operates in a conventional manner in response to user manipulation of the input devices to perform a desired function (e.g., entry of a telephone number, depression of a Push-to-Talk button, etc.).

Communication network operators may define operator-specific applications or software modules 15 (FIG. 1B) on circuit card 12. The applications may be stored within and/or utilize toolkit module 14 of toolkit 26 (FIG. 1A) to control and/or use specific functions of the mobile terminal (e.g., sending a Short Message Service (SMS) message to the network, playing a tone on the mobile terminal, displaying text or an icon on the display of the mobile terminal, etc.). Toolkit 26 provides operators with a standardized Application Programming Interface (API) to enable placement of operator-specific applications on the circuit card independent of the particular operator, circuit card manufacturer and mobile terminal manufacturer. Toolkit 26 further provides a standardized execution environment for applications 15 stored on the circuit card (e.g., UICC/USIM) and the ability to utilize certain functions of the supporting mobile terminal. In other words, toolkit 26 basically serves as a standardized interface between, and defines a standardized command set for, circuit card 12 and mobile communication terminal 16, thereby providing mechanisms to allow applications residing on the circuit card to interact with and operate the mobile terminal.

Toolkit 26 is preferably implemented by a USIM Application Toolkit (USAT) modified in accordance with the present invention to further include several commands to accommodate Push-to-Talk functionality as described below. However, toolkit 26 may be implemented by any toolkits or interfaces enabling control of the mobile terminal by the circuit card. Toolkit 26 preferably includes toolkit modules 14, 21 respectively residing on the circuit card and mobile terminal to define toolkit commands and/or messages transferred therebetween. In particular, a desired application 15 for the circuit card may use toolkit commands to control various mobile terminal functions (e.g., display, loudspeaker, etc.) as described above. The operations (e.g., generation and transmission of toolkit messages to control mobile terminal functions, etc.) associated with toolkit commands are defined within toolkit module 14. When a toolkit command is encountered (e.g., during execution of a circuit card application or received from the mobile terminal), the circuit card processor performs the operations associated with that command in accordance with the command definition within toolkit module 14.

The mobile terminal includes software modules or applications to perform various mobile terminal operations (e.g., display, loudspeaker, etc.) as described above. These operations may be performed in response to toolkit commands received from the circuit card as described above. The operations associated with toolkit commands are defined within toolkit module 21. When a toolkit command is encountered (e.g., during execution of a mobile terminal application or received from the circuit card), the mobile terminal controller performs the operations associated with that command in accordance with the command definition within toolkit module 21.

In order to enable the circuit card to control Push-to-Talk operations of the mobile terminal, toolkit modules 14, 21 of the present invention further include commands pertaining to Push-to-Talk operations. The manner of operation of the Push-to-Talk toolkit commands to control Push-to-Talk sessions is described below. Further, the mobile terminal may include additional applications, or current mobile terminal applications associated with Push-to-Talk operations (e.g., Push-to-Talk client 23, etc.) may be modified to include or accommodate the Push-to-Talk toolkit commands to enable control of the Push-to-Talk operations by the circuit card. Toolkit 26 and corresponding toolkit modules 14, 21 may be implemented by any quantity of hardware (e.g., circuitry, processor, etc.) and/or software modules residing on the circuit card and/or mobile terminal in any fashion (e.g., circuit card processor 17 and/or memory 11 of FIG. 1B, mobile terminal controller 20 and/or memory 22 of FIG. 1C, etc.) to enable interpretation of transferred toolkit messages and/or commands.

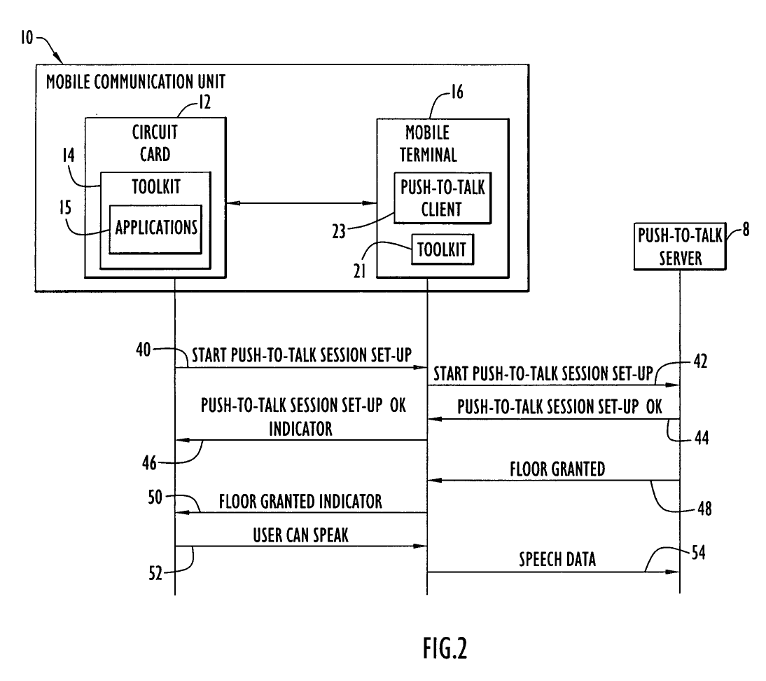

Mobile communication unit 10 of the present invention enables circuit card 12 to control initiation and termination of a Push-to-Talk session for mobile terminal 16, thereby enabling a communication system operator to define and develop applications for the circuit card that utilize the Push-to-Talk features of the mobile terminal. The circuit card, mobile terminal and Push-to-Talk server each typically include software modules or applications (e.g., operator-defined applications 15 of the circuit card, Push-to-Talk client 23 of the mobile terminal, Push-to-Talk server applications, etc.) directing control of their respective operations. Further, the circuit card and mobile terminal are each able to interpret toolkit commands and/or messages to perform corresponding operations as described above. A manner in which a Push-to-Talk session for a pre-arranged user group is initiated by the circuit card according to the present invention is illustrated in FIG. 2. Specifically, an application 15 on circuit card 12 needs to use a Push-to-Talk function of mobile terminal 16. The circuit card requests initiation of a Push-to-Talk session set-up from the mobile terminal by sending a toolkit initiation message or command (e.g., START PUSH-TO-TALK SESSION SET-UP as viewed in FIG. 2) to the mobile terminal at flow 40 in accordance with application 15 and toolkit module 14. This message includes required information (e.g., Push-to-Talk server address, addresses of the Push-to-Talk group, entities and/or persons associated with the session, etc.) to initiate the requested Push-to-Talk session.

The mobile terminal receives and interprets the toolkit initiation message (e.g., START PUSH-TO-TALK SESSION SET-UP) and performs the appropriate actions (e.g., initiate a Push-to-Talk session) in accordance with Push-to-Talk client 23 and operations defined for the toolkit message within toolkit module 21. In particular, the mobile terminal extracts the relevant information (e.g., Push-to-Talk server address, addresses of the Push-to-Talk group, entities and/or persons associated with the requested session, etc.) from the toolkit initiation message (e.g., START PUSH-TO-TALK SESSION SET-UP) and uses the extracted information to generate a create session message (e.g., PUSH-TO-TALK SESSION SET-UP as viewed in FIG. 2) for transmission to Push-to-Talk server 8 at flow 42. The Push-to-Talk server establishes the requested Push-to-Talk session in a conventional manner for the session participants (e.g., Push-to-Talk groups, entities and/or persons) indicated within the create session message.

When the Push-to-Talk session cannot be established, the Push-to-Talk server sends an error message to the mobile terminal. Otherwise, the Push-to-Talk server transmits at flow 44 a session confirmation message (e.g., PUSH-TO-TALK SESSION SET-UP OK as viewed in FIG. 2) to the mobile terminal including a session identification (e.g., Push-to-Talk session ID) identifying the established Push-to-Talk session. The mobile terminal receives this message and generates a toolkit session indicator message including a session established indicator (e.g., PUSH TO TALK SESSION SET-UP OK INDICATOR as viewed in FIG. 2) and the session identification for transmission to the circuit card at flow 46 in accordance with Push-to-Talk client 23 and toolkit module 21.

Once the Push-to-Talk session is established, the initiating user is automatically granted the floor to speak as described above. When the floor is granted, the Push-to-Talk server transmits a floor granted message (e.g., FLOOR GRANTED as viewed in FIG. 2) to the mobile terminal at flow 48. Once the mobile terminal receives the floor granted message from the Push-to-Talk server, the mobile terminal sends a toolkit floor granted message including a floor granted indicator (e.g., FLOOR GRANTED INDICATOR as viewed in FIG. 2) to the circuit card at flow 50 in accordance with Push-to-Talk client 23 and toolkit module 21.

The circuit card receives and interprets the toolkit session indicator and floor granted messages and performs the appropriate actions in accordance with application 15 and operations defined for the toolkit message within toolkit module 14. In particular, the circuit card waits for reception of the session confirmation and floor granted indicators (e.g., PUSH TO TALK SESSION SET-UP OK INDICATOR and FLOOR GRANTED INDICATOR of flows 46 and 50 as viewed in FIG. 2) to confirm establishment of the session prior to enabling the user to speak. When these messages are received, the circuit card generates a toolkit user voice message (e.g., USER CAN SPEAK as viewed in FIG. 2) for transmission to mobile terminal 16 at flow 52 in accordance with application 15 and toolkit module 14. The message typically includes a particular mobile terminal indicator (e.g., display, speaker, etc.) designated for actuation to notify the user of an established Push-to-Talk session and to commence speaking.

The mobile terminal receives and interprets the toolkit user voice message and performs the appropriate actions in accordance with Push-to-Talk client 23 and the operations defined for the toolkit message within toolkit module 21. In particular, the mobile terminal activates the particular indicator (e.g., display, speaker, etc.) identified in the user voice message to notify a user that the Push-to-Talk session is established and the mobile terminal is awaiting user voice signals. When the user speaks (e.g., via a Push-to-Talk button, etc.), the speech data is transmitted from the mobile terminal to the Push-to-Talk server at flow 54 for transference to the participants associated with the Push-to-Talk session. The established Push-to-Talk session is subsequently conducted in a conventional manner. The user may manipulate the mobile terminal to initiate further Push-to-Talk or other communications functions. In addition, the circuit card may transmit and/or exchange toolkit messages with the mobile terminal in substantially the same manner described above to initiate further Push-to-Talk or other communications functions depending on the particular application residing on the circuit card.

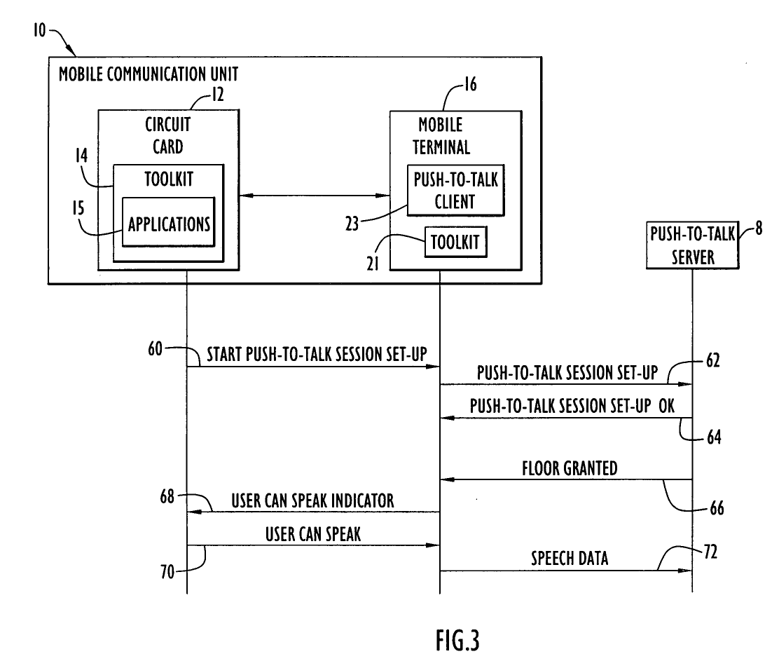

The manner in which a Push-to-Talk session may alternatively be initiated by the circuit card for a pre-arranged user group according to the present invention is illustrated in FIG. 3. Specifically, an application 15 on circuit card 12 needs to use a Push-to-Talk function of mobile terminal 16. The circuit card requests initiation of a Push-to-Talk session set-up from the mobile terminal by sending a toolkit initiation message (e.g., START PUSH-TO-TALK SESSION SET-UP as viewed in FIG. 3) to the mobile terminal at flow 60 in accordance with application 15 and toolkit module 14. This message includes information (e.g., Push-to-Talk server address, addresses of the Push-to-Talk group, entities and/or persons associated with the session, etc.) required to initiate the requested Push-to-Talk session.

The mobile terminal receives and interprets the toolkit initiation message (e.g., START PUSH-TO-TALK SESSION SET-UP) and performs the appropriate actions (e.g., initiate a Push-to-Talk session) in accordance with Push-to-Talk client 23 and the operations defined for the toolkit message within toolkit module 21. In particular, the mobile terminal extracts the relevant information (e.g., Push-to-Talk server address, addresses of the Push-to-Talk group, entities and/or persons associated with the requested session, etc.) from the initiation message (e.g., START PUSH-TO-TALK SESSION SET-UP) and uses the extracted information to generate a create session message (e.g., PUSH-TO-TALK SESSION SET-UP as viewed in FIG. 3) for transmission to Push-to-Talk server 8 at flow 62. The Push-to-Talk server establishes the requested Push-to-Talk session in a conventional manner for the session participants (e.g., Push-to-Talk groups, entities and/or persons) indicated within the create session message.

When the Push-to-Talk session cannot be established, the Push-to-Talk server sends an error message to the mobile terminal. Otherwise, the Push-to-Talk server transmits at flow 64 a session confirmation message (e.g., PUSH-TO-TALK SESSION SET-UP OK as viewed in FIG. 3) to the mobile terminal including a session identification (e.g., Push to Talk Session ID) identifying the established Push-to-Talk session.

Once the Push-to-Talk session is established, the initiating user is automatically granted the floor to speak as described above. When the floor is granted, the Push-to-Talk server transmits a floor granted message (e.g., FLOOR GRANTED as viewed in FIG. 3) to the mobile terminal at flow 66. The mobile terminal waits for reception of the session confirmation and floor granted messages (e.g., PUSH TO TALK SESSION SET-UP OK and FLOOR GRANTED of flows 64 and 66 as viewed in FIG. 3) from the Push-to-Talk server to confirm establishment of the session prior to enabling the user to speak. When these messages are received, the mobile terminal generates a toolkit voice enable message including a speak indicator (e.g., USER CAN SPEAK INDICATOR as viewed in FIG. 3) and the session identification for transmission to circuit card 12 at flow 68 in accordance with Push-to-Talk client 23 and toolkit module 21. The message indicates establishment of a Push-to-Talk session and that the user may commence speaking.

The circuit card receives and interprets the toolkit voice enable message and performs the appropriate actions in accordance with application 15 and the operations defined for the toolkit message within toolkit module 14. In particular, the circuit card generates a toolkit user voice message (e.g., USER CAN SPEAK as viewed in FIG. 3) for transmission to the mobile terminal at flow 70. The message typically includes a particular mobile terminal indicator (e.g., display, speaker, etc.) designated for actuation to notify the user of an established Push-to-Talk session and to commence speaking.

The mobile terminal receives and interprets the toolkit user voice message and performs the appropriate actions in accordance with Push-to-Talk client 23 and the operations defined for the toolkit message within toolkit module 21. Specifically, the mobile terminal activates the indicator (e.g., display, speaker, etc.) identified in the user voice message to notify a user that the Push-to-Talk session is established and the mobile terminal is awaiting user voice signals. When the user speaks (e.g., via a Push-to-Talk button, etc.), the speech data is transmitted from the mobile terminal to the Push-to-Talk server at flow 72 for transference to the participants associated with the Push-to-Talk session. The established Push-to-Talk session is subsequently conducted in a conventional manner. The user may manipulate the mobile terminal to initiate further Push-to-Talk or other communications functions. In addition, the circuit card may transmit and/or exchange toolkit messages with the mobile terminal in substantially the same manner described above to initiate further Push-to-Talk or other communications functions depending on the particular application residing on the circuit card.

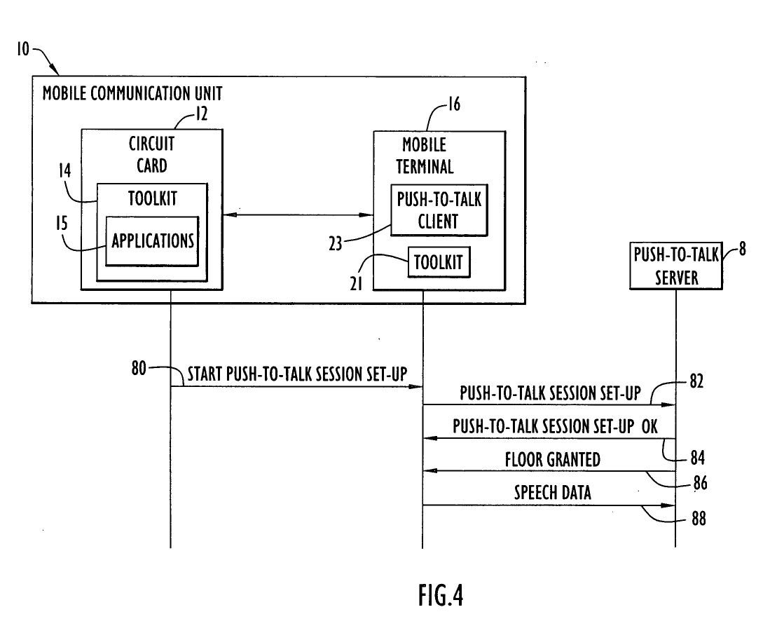

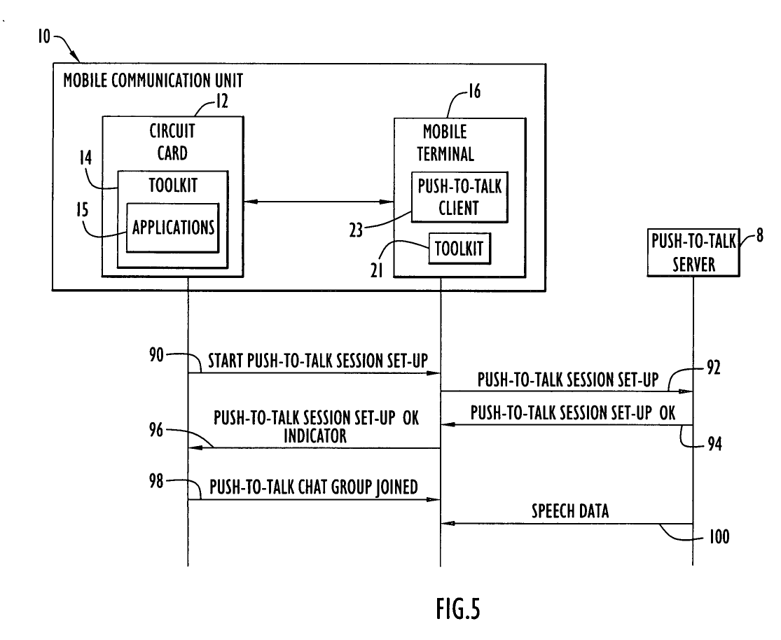

Yet another manner in which a Push-to-Talk session may be initiated by the circuit card for a pre-arranged user group according to the present invention is illustrated in FIG. 4. Specifically, an application 15 on circuit card 12 needs to use a Push-to-Talk function of mobile terminal 16. The circuit card requests initiation of a Push-to-Talk session set-up from the mobile terminal by sending a toolkit initiation message (e.g., START PUSH-TO-TALK SESSION SET-UP as viewed in FIG. 4) to the mobile terminal at flow 80 in accordance with application 15 and toolkit module 14. This message includes required information (e.g., Push-to-Talk server address, addresses of the Push-to-Talk group, entities and/or persons associated with the session, etc.) to initiate the requested Push-to-Talk session.

The mobile terminal receives and interprets the toolkit initiation message (e.g., START PUSH-TO-TALK SESSION SET-UP) and performs the appropriate actions (e.g., initiate a Push-to-Talk session) in accordance with Push-to-Talk client 23 and the operations defined for the toolkit message within toolkit module 21. In particular, the mobile terminal extracts the relevant information (e.g., Push-to-Talk server address, addresses of the Push-to-Talk group, entities and/or persons associated with the requested session, etc.) from the initiation message (e.g., START PUSH-TO-TALK SESSION SET-UP) and uses the extracted information to generate a create session message (e.g., PUSH-TO-TALK SESSION SET-UP as viewed in FIG. 4) for transmission to Push-to-Talk server 8 at flow 82. The Push-to-Talk server establishes the requested Push-to-Talk session in a conventional manner for the session participants (e.g., Push-to-Talk groups, entities and/or persons) indicated within the create session message.

When the Push-to-Talk session cannot be established, the Push-to-Talk server sends an error message to the mobile terminal. Otherwise, the Push-to-Talk server transmits at flow 84 a session confirmation message (e.g., PUSH-TO-TALK SESSION SET-UP OK as viewed in FIG. 4) to the mobile terminal including a session identification (e.g., Push-to-Talk Session ID) identifying the established Push-to-Talk session. Once the Push-to-Talk session is established, the initiating user is automatically granted the floor to speak as described above. When the floor is granted, the Push-to-Talk server transmits a floor granted message (e.g., FLOOR GRANTED as viewed in FIG. 4) to the mobile terminal at flow 86.

Since the mobile terminal previously received the toolkit initiation message from the circuit card (e.g., START PUSH-TO-TALK SESSION SET-UP at flow 80) requesting initiation of a session, the mobile terminal waits for reception of the session confirmation and floor granted messages (e.g., PUSH-TO-TALK SESSION SET-UP OK and FLOOR GRANTED of flows 84 and 86 as viewed in FIG. 4) from the Push-to-Talk server to confirm establishment of the session and perform appropriate actions in accordance with Push-to-Talk client 23 and toolkit module 21. In particular, once these messages are received, the mobile terminal activates an indicator (e.g., display, speaker, etc.) to notify a user that the Push-to-Talk session is established and the mobile terminal is awaiting user voice signals. When the user speaks (e.g., via a Push-to-Talk button, etc.), the speech data is transmitted from the mobile terminal to the Push-to-Talk server at flow 88 for transference to the participants associated with the Push-to-Talk session. The established Push-to-Talk session is subsequently conducted in a conventional manner. Thus, this technique enables circuit card 12 to control establishment of a Push-to-Talk session via transference of a single toolkit message to mobile terminal 16. The user may manipulate the mobile terminal to initiate further Push-to-Talk or other communications functions. In addition, the circuit card may transmit and/or exchange toolkit messages with the mobile terminal in substantially the same manner described above to initiate further Push-to-Talk or other communication functions based on the particular application on the circuit card.

The manner in which a Push-to-Talk session is initiated by the circuit card to enable a user to join a chat group according to the present invention is illustrated in FIG. 5. Initially, an application 15 on the circuit card may desire to join a user to an existing Push-to-Talk chat group session. The mobile terminal establishes a Push-to-Talk session with the Push-to-Talk server, thereby automatically joining the user to the existing Push-to-Talk chat group session. Specifically, an application 15 on circuit card 12 needs to use a Push-to-Talk function (e.g., join a chat group) of mobile terminal 16. The circuit card requests initiation of a Push-to-Talk session set-up from the mobile terminal by sending a toolkit initiation message (e.g., START PUSH-TO-TALK SESSION SET-UP as viewed in FIG. 5) to the mobile terminal at flow 90 in accordance with application 15 and toolkit module 14. This message includes required information (e.g., Push-to-Talk server address, address of the desired chat group, etc.) to initiate the requested Push-to-Talk session.

The mobile terminal receives and interprets the toolkit initiation message (e.g., START PUSH-TO-TALK SESSION SET-UP) and performs the appropriate actions (e.g., initiate a Push-to-Talk session) in accordance with Push-to-Talk client 23 and the operations defined for the toolkit message within toolkit module 21. In particular, the mobile terminal extracts the relevant information (e.g., Push-to-Talk server address, address of the chat group, etc.) from the toolkit initiation message (e.g., START PUSH-TO-TALK SESSION SET-UP) and uses the extracted information to generate a create session message (e.g., PUSH-TO-TALK SESSION SET-UP as viewed in FIG. 5) for transmission to Push-to-Talk server 8 at flow 92. The Push-to-Talk server adds the user to the chat group session indicated within the create session message in a conventional manner.

When the user cannot be joined to the chat group session, the Push-to-Talk server sends an error message to the mobile terminal. Otherwise, the Push-to-Talk server transmits at flow 94 a session confirmation message (e.g., PUSH-TO-TALK SESSION SET-UP OK as viewed in FIG. 5) to the mobile terminal including a session identification (e.g., Push-to-Talk Session ID) identifying the Push-to-Talk chat group session the user has joined. Since a user joining a chat group needs to request the floor to speak as described above, the mobile terminal does not automatically receive a floor granted message from the Push-to-Talk server in response to the user joining the chat group.

The mobile terminal receives the session confirmation message from the Push-to-Talk server and generates (e.g., in accordance with Push-to-Talk client 23 and toolkit module 21) a toolkit session indicator message including a session established indicator (e.g., PUSH-TO-TALK SESSION SET-UP OK INDICATOR as viewed in FIG. 5) and the session identification for transmission to the circuit card at flow 96, thereby establishing user participation in the chat group.

The circuit card receives and interprets the toolkit session indicator message and performs the appropriate actions in accordance with application 15 and the operations defined for the toolkit message within toolkit module 14. In order to enable receipt of speech data from the chat group, the circuit card may further generate a toolkit join message (e.g., PUSH-TO-TALK CHAT GROUP JOINED as viewed in FIG. 5) including a designated mobile terminal indicator for transmission to the mobile terminal at flow 98 in accordance with application 15 and toolkit module 14. The mobile terminal receives and interprets the toolkit join message and performs the appropriate actions in accordance with Push-to-Talk client 23 and the operations defined for the toolkit message within toolkit module 21. In particular, the mobile terminal activates the indicator (e.g., display, speaker, etc.) identified in the join message to notify a user that the Push-to-Talk chat group session has been joined. Once the mobile terminal receives the toolkit join message, speech data may be received by the mobile terminal from Push-to-talk server 8 at flow 100. The speech data may further be transferred to the circuit card. The established Push-to-Talk session may subsequently be conducted in a conventional manner. The user may manipulate the mobile terminal to initiate further Push-to-Talk or other communications functions. In addition, the circuit card may transmit and/or exchange toolkit messages with the mobile terminal in substantially the same manner described above to initiate further Push-to-Talk or other communications functions depending on the particular application residing on the circuit card.

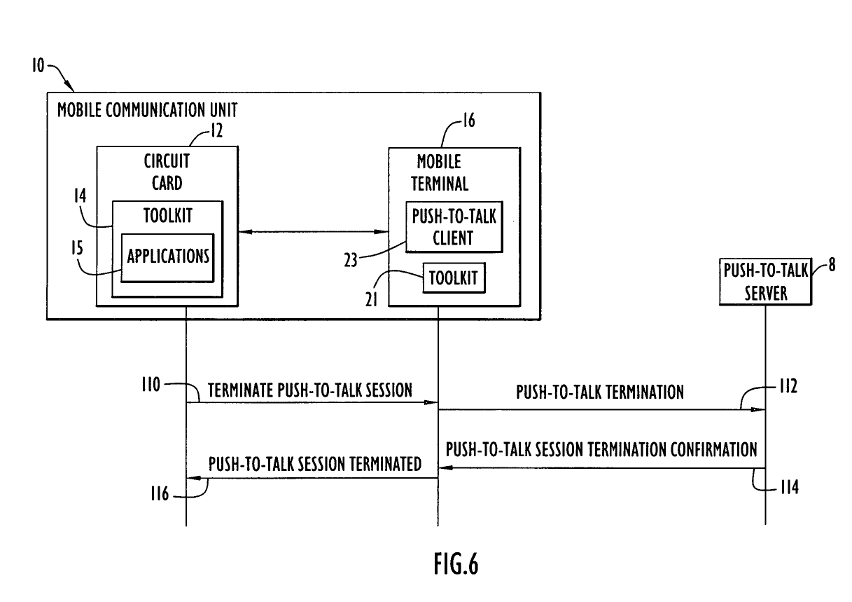

After a Push-to-Talk session (e.g., for a pre-arranged user group or chat group) is established and the desired actions are performed during the session, the Push-to-Talk session for the mobile communication unit is terminated. The manner in which a Push-to-Talk session for a pre-arranged user group or chat group is terminated for a mobile communication unit by the circuit card according to the present invention is illustrated in FIG. 6. Initially, an application 15 on the circuit card may desire to terminate an existing Push-to-Talk session for the mobile communication unit (e.g., terminate participation of that unit in a pre-arranged user group or a chat group). The circuit card requests termination of the Push-to-Talk session by sending a toolkit termination message (e.g., TERMINATE PUSH-TO-TALK SESSION as viewed in FIG. 6) including the session identification (e.g., obtained from the session initiation as described above) to the mobile terminal at flow 110 in accordance with application 15 and toolkit module 14.

The mobile terminal receives and interprets the toolkit termination message (e.g., TERMINATE PUSH-TO-TALK SESSION) and performs the appropriate actions (e.g., terminate the Push-to-Talk session, etc.) in accordance with Push-to-Talk client 23 and the operations defined for the toolkit message within toolkit module 21. In particular, the mobile terminal extracts the relevant information (e.g., session identification, etc.) from the termination message (e.g., TERMINATE PUSH-TO-TALK SESSION) and generates a terminate session message (e.g., PUSH-TO-TALK TERMINATION as viewed in FIG. 6) for transmission to Push-to-Talk server 8 at flow 112. The Push-to-Talk server terminates participation of the mobile communication unit within the session in a conventional manner and transmits at flow 114 a termination confirmation message (e.g., PUSH-TO-TALK SESSION TERMINATION CONFIRMATION as viewed in FIG. 6) to the mobile terminal.

The mobile terminal receives the termination confirmation message from the Push-to-Talk server and generates a toolkit session terminated message (PUSH-TO-TALK SESSION TERMINATED as viewed in FIG. 6) for transmission to the circuit card at flow 116 in accordance with Push-to-Talk client 23 and toolkit module 21. The circuit card receives and interprets the toolkit session terminated message in accordance with application 15 and the operations defined for the toolkit message within toolkit module 14. The message basically informs the circuit card of termination of the session. The user may manipulate the mobile terminal to initiate further Push-to-Talk or other communications functions. In addition, the circuit card may transmit and/or exchange toolkit messages with the mobile terminal in substantially the same manner described above to initiate further Push-to-Talk or other communications functions depending on the particular application residing on the circuit card.

The present invention may be utilized to provide various operator-defined features for a mobile communication unit. For example, a communication network operator may define an application for the circuit card to monitor the mobile terminal functionality. When the user encounters problems with the mobile communication unit, the monitoring application may automatically establish a Push-to-Talk session with a customer care center in substantially the same manner described above. Once the session is established, the user may immediately communicate the problem to personnel at the customer care center.

Further, the circuit card may include an emergency or virtual doctor application. In the event that a user is injured or ill, the application may be initiated to present several questions (e.g., via speech synthesis, display, etc.) concerning the user health. The application evaluates user responses to the questions to determine the seriousness of the injury or illness. When the application determines that the user health warrants additional assistance, the application may automatically initiate a Push-to-Talk session with an actual medical doctor or other medical personnel in substantially the same manner described above.

Moreover, a communication network developer or operator may define games for the circuit card utilizing different functionalities of the mobile terminal (e.g., the display, the loudspeaker, Push-to-Talk, etc.). Since a user needs their hands available for controlling game input devices (e.g., keypad, joystick, button, etc.) during game play, the game may initiate a Push-to-Talk session (e.g., based on speech or voice commands, etc.) for the user in substantially the same manner described above.

In addition, there may be several instances when a user desires to initiate a Push-to-Talk session in a hands-free manner (e.g., without depressing the Push-to-Talk button or other control device of the mobile communication unit). For example, a driver of a motorized vehicle (e.g., car, motorcycle, boat, etc.) may desire to utilize Push-to-Talk functions, but is unable to manipulate the mobile terminal control devices during vehicle operation. An application on the circuit card may enable initiation of a Push-to-Talk session in substantially the same manner described above based on user commands entered in various other forms (e.g., speech or voice signals, etc.), thereby providing a hands-free mode of operation.

It will be appreciated that the embodiments described above and illustrated in the drawings represent only a few of the many ways of implementing a method and apparatus for controlling Push-to-Talk functions of a mobile communication unit from a unit circuit card.

The communication system may be implemented by any mobile communication system with any quantity of mobile communication units. The communication system and/or mobile units may support any desired functions (e.g., Push-to-Talk, etc.). The Push-to-Talk server may be implemented by any quantity of any personal or other type of computer system (e.g., IBM-compatible, etc.). The Push-to-Talk server may include any commercially available operating system, any commercially available or custom software (e.g., server software, communication software, etc.) and any types of input devices (e.g., keyboard, mouse, voice recognition, etc.). The Push-to-Talk server may perform any desired communication system functions and/or facilitate any communication system features (e.g., Push-to-Talk, etc.). The Push-to-Talk server may include any conventional or other communications devices to communicate with the mobile communication units and/or other communication system components (e.g., other servers, base stations, etc.). The communication service network may be implemented by any quantity of any conventional or other communication networks and may include any quantity of any conventional or other components for transfer of information (e.g., base stations, computer and/or server systems, interfaces to telephone system lines, etc.) via any suitable communication medium (e.g., LAN, WAN, wireless, wired, etc.).

The communication unit may be in the form of any type of radio unit or other communications device (e.g., mobile telephone, PDA, etc.). The communication unit may include any quantity of any conventional or other mobile terminal or communication device to communicate with the communication service network. The communication unit may employ any quantity of controllers, processors or processing devices or circuitry (e.g., within the mobile terminal and/or circuit card, as a stand-alone component, etc.), where the various functions of the circuit card and/or mobile terminal may be distributed in any fashion among any quantity of hardware and/or software modules, processors or other processing devices or circuits. The various communication unit components (e.g., mobile terminal, circuit card, etc.) may be disposed at any desired locations and arranged in any fashion.

The mobile terminal may include any quantity of any conventional or other antennas, transmitters, receivers and/or transceivers, where each transmitter or transceiver may transmit signals at any suitable frequency and in any suitable energy form (e.g., radio signals, microwave, optical signals, etc.), and any quantity of conventional or other receivers or transceivers, where each receiver or transceiver may receive signals at any suitable frequency and in any suitable energy form (e.g., radio signals, microwave, optical signals, etc.). The mobile terminal may include any quantity of independent transmitting and/or receiving devices, and utilize any quantity of frequency channels of any desired frequencies to send voice and/or data. The mobile terminal may include any quantity of any conventional or other voice components (e.g., speaker, microphone, etc.). The mobile terminal may further include a digital signal processor, where the digital signal processor and/or controller may perform any desired signal processing functions (e.g., coder, A/D or D/A converter, filtering, encryption/decryption, etc.) to process voice signals. The input devices may include any quantity of any types of input or control devices (e.g., buttons, switches, etc.) to enter voice or data and control unit operation. The display may be of any size or shape and may be implemented by any quantity of any conventional or other display devices (e.g., LCD, LED, etc.). The mobile terminal may include any desired indicators to inform a user of particular conditions (e.g., icons or messages on the display, visual or audio indicators, speech synthesis, etc.). The various mobile terminal components (e.g., voice devices, input devices, display, controller, transmitter, receiver, memory, etc.) may be disposed at any desired locations and arranged in any fashion.

The controller of the mobile terminal may be implemented by any quantity of any conventional or other microprocessor, controller or circuitry to perform any desired communication or other functions. The various functions of the mobile terminal may be distributed in any fashion among any quantity of hardware and/or software modules, processors or other processing devices or circuits. The mobile terminal memory may be implemented by any quantity of any type of conventional or other memory or storage units (e.g., ROM, RAM, Flash, etc.) and may store any desired information. The mobile terminal may include any desired software applications (e.g., Push-to-Talk client, etc.) to perform communications or other functions.

The circuit card may be implemented by any quantity of any conventional or other memory, processing and/or storage units (e.g., memory circuitry, IC, smart card, etc.). The circuit card processor may be implemented by any quantity of any conventional or other processor, controller and/or processing circuitry to perform any desired communication or other functions. The various functions of the circuit card may be distributed in any fashion among any quantity of hardware and/or software modules, processors or other processing devices or circuits. The circuit card memory may be implemented by or include any quantity of any type of conventional or other memory or storage units (e.g., ROM, RAM, Flash, USIM or other subscriber module, etc.) and may store any desired information. The circuit card may include any desired operator-defined, user-defined or other applications (e.g., software and/or hardware modules) to control the mobile terminal functions. The various circuit card components (e.g., processor, memory, etc.) may be disposed at any desired locations and arranged in any fashion.

The toolkit may be implemented by any suitable interface (e.g., API, interpreter, compiler, translator, assembler, etc.) to enable transference of commands compatible with the circuit card and mobile terminal. The various functions of the toolkit may be distributed in any fashion among any quantity of hardware and/or software modules, processors or other processing devices or circuits. The toolkit may reside on the circuit card, mobile terminal and/or Push-to-Talk server in any fashion. Alternatively, the toolkit may be implemented as a stand-alone unit (e.g., hardware and/or software modules) in communication with the circuit card, mobile terminal and/or Push-to-Talk server. The toolkit may define and/or accommodate any quantity of any desired Push-to-Talk commands performing any suitable actions to control the mobile terminal Push-to-Talk capability (e.g., Push-to-Talk initiation and/or termination, floor requests, user speaking and/or listening, etc.). The toolkit may further define and/or accommodate commands for any desired mobile terminal functions (e.g., dial a telephone number, control voice devices and/or indicators, etc.). Any desired components (e.g., circuit card, mobile terminal, Push-to-Talk server, etc.) of the communication system may include additional hardware and/or software modules (e.g., applications, etc.), and/or the component hardware and/or software modules (e.g., toolkit, applications, Push-to-Talk client, etc.) may be modified, to accommodate the toolkit and/or Push-to-Talk toolkit commands to enable the circuit card to control the Push-to-Talk functions of the mobile terminal. The various functions of the toolkit may be distributed in any fashion between the toolkit and corresponding applications (e.g., Push-to-Talk client, operator-defined application, Push-to-Talk server application, etc.) to perform toolkit commands (e.g., the toolkit functions may be performed by the toolkit modules, by the applications or in any combination thereof).

The messages between the circuit card and mobile terminal may be of any desired length and format and may include any quantity of fields with any desired information. The messages may be transmitted in any desired fashion or order enabling control (e.g., initiation, termination, confirmation, etc.) of any desired mobile terminal communication or other functions (e.g., Push-to-Talk, dial a telephone number, control the voice devices, indicators and/or display, etc.). The various indicators (e.g., session established indicator, floor granted indicator, etc.) may include any desired information (e.g., flags, message, text, alphanumeric codes, etc.) to indicate conditions. The messages between the Push-to-Talk server and mobile terminal may be of any desired length and format and may include any quantity of fields with any desired information. The messages may be transmitted in any desired fashion or order enabling communication or other functions (e.g., Push-to-Talk, etc.).

The software of the present invention (e.g., toolkit modules, Push-to-Talk client, circuit card, mobile terminal and/or Push-to-Talk server applications, etc.) may be implemented in any suitable computer language, and could be developed by one of ordinary skill in the computer and/or programming arts based on the functional description contained herein and the flow diagrams illustrated in the drawings. Further, any references herein of software performing various functions generally refer to processors performing those functions under software control. The software and/or algorithms described above and illustrated in the flow diagrams may be modified in any manner that accomplishes the functions described herein.

The present invention may be available in the form of a mobile communication device, or a circuit card for the communication device and/or mobile terminal performing the functions described above. The present invention may alternatively be available in the form of hardware and/or software modules (e.g., card, etc.) for use on the mobile communication unit, circuit card and/or mobile terminal, or may be in the form of embeddable hardware and/or software modules (e.g., within another system, as an embeddable software component within other software, software or library accessed during compilation, translation or assembly of an application, etc.). The present invention software for various communication system components (e.g., circuit card, mobile terminal, toolkit modules, Push-to-Talk server, etc.) may be available individually, or in any combination, on a recordable medium (e.g., magnetic or optical mediums, magneto-optic mediums, floppy diskettes, CD-ROM, DVD, memory devices (e.g., cards, ROM, RAM, Flash, etc.), etc.), and/or may be downloaded (e.g., in the form of carrier waves, packets, etc.) to systems and/or communication units via a network or other communications medium. The present invention toolkit may include software modules (e.g., firmware, high and/or low level code, etc.), libraries (e.g., including software to define toolkit commands and accessible to software applications, etc.), software applications or procedures, operating environments, Application Programming Interfaces (APIs) or any combinations thereof.

The present invention is not limited to the applications described above, but may be applied to any types of mobile communication units and/or communication systems supporting Push-to-Talk or other one-to-one or group communications capabilities. Further, the present invention may be utilized to enable operator applications to control any desired communication or other features of the mobile terminal from the circuit card.

From the foregoing description, it will be appreciated that the invention makes available a novel method and apparatus for controlling Push-to-Talk functions of a mobile communication unit from a unit circuit card, wherein Push-to-Talk functions of a mobile terminal are controlled by a circuit card within the mobile communication unit.

Having described preferred embodiments of a new and improved method and apparatus for controlling Push-to-Talk functions of a mobile communication unit from a unit circuit card, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A mobile communication unit of a communication system supporting Push-to-Talk communication between communication units of said system comprising:
a communication application module to store communication parameters and facilitate performance of specified communication functions including a Push-to-Talk communication with another communication unit;
a communication device coupled to said communication application module and supporting Push-to-Talk communications within said communication system, wherein said communication device includes at least one input device and performs communication functions including said Push-to-Talk communication in accordance with at least one of said communication application module and user manipulation of at least one input device; and
an interface module to interface said communication application module and said communication device to enable said communication application module to control said communication device to perform said specified communication functions including said Push-to-Talk communication.

2. The mobile communication unit of claim 1, wherein said interface module includes an application interface module residing on said communication application module and a device interface module residing on said communication device to interface said communication application module and said communication device.

3. The mobile communication unit of claim 2, wherein said communication application module includes:
a memory unit to store said communication parameters;
said application interface module to define an interface between said communication application module and said communication device including a set of compatible commands, wherein said command set includes at least one command associated with Push-to-Talk communications and said application interface module includes at least one application module utilizing a Push-to-Talk command to control said communication device to perform a Push-to-Talk communication; and
a processor to facilitate communication functions in accordance with said at least one application module.

4. The mobile communication unit of claim 2, wherein said communication system includes a Push-to-Talk server system to control Push-to-Talk communications and said communication device includes:
a transceiver unit to transmit and receive information with said communication system;
said device interface module to define an interface between said communication application module and said communication device including a set of compatible commands, wherein said command set includes at least one command associated with Push-to-Talk communications to enable said communication application module to control said communication device to perform a Push-to-Talk communication;
a Push-to-Talk module to facilitate communication with said Push-to-Talk server system and performance of said Push-to-Talk communications within said communication system; and
a controller to control performance of communication functions including said Push-to-Talk communication in accordance with at least one of said communication application module, said Push-to-Talk module and user manipulation of at least one input device.

5. The mobile communication unit of claim 1, wherein said interface module includes:
a session initiation module to interface said communication application module and said communication device to enable said communication application module to control said communication device to initiate a Push-to-Talk communication session.

6. The mobile communication unit of claim 5, wherein said interface module further includes:
a session termination module to interface said communication application module and said communication device to enable said communication application module to control said communication device to terminate an established Push-to-Talk communication session.

7. A mobile communication unit of a communication system supporting Push-to-Talk communication between communication units of said system comprising:
communication application means for storing communication parameters and facilitating performance of specified communication functions including a Push-to-Talk communication with another communication unit;
communication means coupled to said communication application means and supporting Push-to-Talk communications within said communication system, wherein said communication means includes at least one input device and performs communication functions including said Push-to-Talk communication in accordance with at least one of said communication application means and user manipulation of at least one input device; and
interface means for interfacing said communication application means and said communication means to enable said communication application means to control said communication means to perform said specified communication functions including said Push-to-Talk communication.

8. The mobile communication unit of claim 7, wherein said interface means includes application interface means residing on said communication application means and device interface means residing on said communication means for interfacing said communication application means and said communication means.

9. The mobile communication unit of claim 8, wherein said communication application means includes:
memory means for storing said communication parameters;
said application interface means for defining an interface between said communication application means and said communication means including a set of compatible commands, wherein said command set includes at least one command associated with Push-to-Talk communications and said application interface means includes at least one application means utilizing a Push-to-Talk command for controlling said communication means to perform a Push-to-Talk communication; and
processing means for facilitating communication functions in accordance with said at least one application means.

10. The mobile communication unit of claim 8, wherein said communication system includes a Push-to-Talk server system to control Push-to-Talk communications and said communication means includes:
transceiver means for transmitting and receiving information with said communication system;
said device interface means for defining an interface between said communication application means and said communication means including a set of compatible commands, wherein said command set includes at least one command associated with Push-to-Talk communications to enable said communication application means to control said communication means to perform a Push-to-Talk communication;
Push-to-Talk means for facilitating communication with said Push-to-Talk server system and performance of said Push-to-Talk communications within said communication system; and
control means for controlling performance of communication functions including said Push-to-Talk communication in accordance with at least one of said communication application means, said Push-to-Talk means and user manipulation of at least one input device.

11. The mobile communication unit of claim 7, wherein said interface means includes:
session initiation means for interfacing said communication application means and said communication means to enable said communication application means to control said communication means to initiate a Push-to-Talk communication session.

12. The mobile communication unit of claim 11, wherein said interface means further includes:
session termination means for interfacing said communication application means and said communication means to enable said communication application means to control said communication means to terminate an established Push-to-Talk communication session.

13. An interface between a communication application module and a communication device of a mobile communication unit supporting Push-to-Talk communications between communication units of a communication system, wherein said interface enables said communication application module to control said communication device to perform Push-to-Talk communications, said interface comprising:
an interface module to form an interface between said communication application module and said communication device including a set of compatible commands, wherein said command set includes at least one command associated with Push-to-Talk communications to enable said communication application module to control said communication device to perform Push-to-Talk communications.

14. The interface of claim 13, wherein said interface module includes:
an application interface module residing on said communication application module to associate actions with corresponding commands within said command set including said Push-to-Talk commands to enable said communication application module to control said communication device to perform a Push-to-Talk communication.

15. The interface of claim 14, wherein said interface module further includes:
a device interface module residing on said communication device to associate actions with corresponding commands within said command set including said Push-to-Talk commands to enable said communication application module to control said communication device to perform a Push-to-Talk communication.

16. The interface of claim 15, wherein said interface module further includes:
a Push-to-Talk module residing on said communication device to facilitate performance of said Push-to-Talk communications within said communication system in accordance with said Push-to-Talk commands.

17. The interface of claim 13, wherein said interface module includes:
a session initiation module to form said interface between said communication application module and said communication device to include an initiate command to enable said communication application module to control said communication device to initiate a Push-to-Talk communication session.

18. The interface of claim 17, wherein said interface module further includes:
a session termination module to form said interface between said communication application module and said communication device to include a terminate command to enable said communication application module to control said communication device to terminate an established Push-to-Talk communication session.

19. A program product apparatus including a computer readable medium with computer program logic recorded thereon for interfacing a communication application module and a communication device of a mobile communication unit supporting Push-to-Talk communications between communication units of a communication system, wherein said interface enables said communication application module to control said communication device to perform Push-to-Talk communications, said program product apparatus comprising:
an interface module to form an interface between said communication application module and said communication device including a set of compatible commands, wherein said command set includes at least one command associated with Push-to-Talk communications to enable said communication application module to control said communication device to perform Push-to-Talk communications.

20. The apparatus of claim 19, wherein said interface module includes:
an application interface module for placement on said communication application module to associate actions with corresponding commands within said command set including said Push-to-Talk commands to enable said communication application module to control said communication device to perform a Push-to-Talk communication.

21. The apparatus of claim 20, wherein said interface module further includes:
a device interface module for placement on said communication device to associate actions with corresponding commands within said command set including said Push-to-Talk commands to enable said communication application module to control said communication device to perform a Push-to-Talk communication.

22. The apparatus of claim 21, wherein said interface module further includes:
a Push-to-Talk module for placement on said communication device to facilitate performance of said Push-to-Talk communications within said communication system in accordance with said Push-to-Talk commands.

23. The apparatus of claim 19, wherein said interface module includes:
a session initiation module to form said interface between said communication application module and said communication device to include an initiate command to enable said communication application module to control said communication device to initiate a Push-to-Talk communication session.

24. The apparatus of claim 23, wherein said interface module further includes:
a session termination module to form said interface between said communication application module and said communication device to include a terminate command to enable said communication application module to control said communication device to terminate an established Push-to-Talk communication session.

25. A carrier signal having computer program logic embedded therein for interfacing a communication application module and a communication device of a mobile communication unit supporting Push-to-Talk communications between communication units of a communication system, wherein said interface enables said communication application module to control said communication device to perform Push-to-Talk communications, said carrier signal comprising:
an interface module to form an interface between said communication application module and said communication device including a set of compatible commands, wherein said command set includes at least one command associated with Push-to-Talk communications to enable said communication application module to control said communication device to perform Push-to-Talk communications.

26. The carrier signal of claim 25, wherein said interface module includes:
an application interface module for placement on said communication application module to associate actions with corresponding commands within said command set including said Push-to-Talk commands to enable said communication application module to control said communication device to perform a Push-to-Talk communication.

27. The carrier signal of claim 26, wherein said interface module further includes:
a device interface module for placement on said communication device to associate actions with corresponding commands within said command set including said Push-to-Talk commands to enable said communication application module to control said communication device to perform a Push-to-Talk communication.

28. The carrier signal of claim 27, wherein said interface module further includes:
a Push-to-Talk module for placement on said communication device to facilitate performance of said Push-to-Talk communications within said communication system in accordance with said Push-to-Talk commands.

29. The carrier signal of claim 25, wherein said interface module includes:
a session initiation module to form said interface between said communication application module and said communication device to include an initiate command to enable said communication application module to control said communication device to initiate a Push-to-Talk communication session.

30. The carrier signal of claim 29, wherein said interface module further includes:
a session termination module to form said interface between said communication application module and said communication device to include a terminate command to enable said communication application module to control said communication device to terminate an established Push-to-Talk communication session.

31. A method of enabling a communication application module of a mobile communication unit to control a communication device of that unit to perform Push-to-Talk communications within a communication system, wherein said mobile communication unit includes an interface between said communication application module and said communication device in the form of a compatible command set and said communication system includes a Push-to-Talk server system to control Push-to-Talk communications within said communication system, said method comprising:
(a) transmitting Push-to-Talk commands of said interface from said communication application module to said communication device to facilitate Push-to-Talk communications; and
(b) communicating information between said communication device and said Push-to-Talk server system to establish Push-to-Talk communications within said communication system in response to said transmitted Push-to-Talk commands.

32. The method of claim 31, wherein said Push-to-Talk communications are for a pre-defined user group and step (a) further includes:
(a.1) transmitting a Push-to-Talk session initiation command from said communication application module to said communication device to facilitate initiation of a Push-to-Talk session for said pre-defined user group;
step (b) further includes:
(b.1) transmitting an initiation message from said communication device to said Push-to-Talk server system to initiate said Push-to-Talk session;
(b.2) receiving an indication of an established session from said Push-to-Talk server system and transmitting an interface message from said communication device to said communication application module including information pertaining to said established session indication; and
(b.3) receiving permission for a user to speak within said established session from said Push-to-Talk server system and transmitting an interface message from said communication device to said communication application module including information pertaining to said received permission;
wherein said method further includes:
(c) transmitting a Push-to-Talk voice command from said communication application module to said communication device to enable said user to commence speaking within said established session in response to said permission message; and
(d) receiving voice signals from said user and transmitting said voice signals from said communication device to said Push-to-Talk server system for transference to said pre-defined user group in response to said voice command.

33. The method of claim 31, wherein said Push-to-Talk communications are for a pre-defined user group and step (a) further includes:
(a.1) transmitting a Push-to-Talk session initiation command from said communication application module to said communication device to facilitate initiation of a Push-to-Talk session for said pre-defined user group;
step (b) further includes:
(b.1) transmitting an initiation message from said communication device to said Push-to-Talk server system to initiate said Push-to-Talk session; and
(b.2) receiving an indication of an established session and permission for a user to speak within said established session from said Push-to-Talk server system and transmitting an interface message from said communication device to said communication application module including information pertaining to said indication;
wherein said method further includes:
(c) transmitting a Push-to-Talk voice command from said communication application module to said communication device to enable said user to commence speaking within said established session in response to said indication message; and
(d) receiving voice signals from said user and transmitting said voice signals from said communication device to said Push-to-Talk server system for transference to said pre-defined user group.

34. The method of claim 31, wherein said Push-to-Talk communications are for a pre-defined user group and step (a) further includes:
(a.1) transmitting a Push-to-Talk session initiation command from said communication application module to said communication device to facilitate initiation of a Push-to-Talk session for said pre-defined user group;
step (b) further includes:
(b.1) transmitting an initiation message from said communication device to said Push-to-Talk server system to initiate said Push-to-Talk session;
(b.2) receiving an indication of an established session and permission for a user to speak within said established session from said Push-to-Talk server system; and
(b.3) receiving voice signals from said user and transmitting said voice signals from said communication device to said Push-to-Talk server system for transference to said pre-defined user group in response to said received indication.

35. The method of claim 31, wherein said Push-to-Talk communications are for a chat group and step (a) further includes:
(a.1) transmitting a Push-to-Talk session initiation command from said communication application module to said communication device to facilitate initiation of a Push-to-Talk session to join a user to said chat group;
step (b) further includes:
(b.1) transmitting an initiation message from said communication device to said Push-to-Talk server system to initiate said Push-to-Talk session; and
(b.2) receiving an indication of an established session from said Push-to-Talk server system and transmitting an interface message from said communication device to said communication application module including information pertaining to said indication;
wherein said method further includes:
(c) transmitting an interface join message from said communication application module to said communication device to enable said user to commence listening within said established session in response to said indication message; and
(d) receiving voice signals pertaining to said chat group at said communication device from said Push-to-Talk server system and conveying said voice signals to said user in response to said join message.

36. The method of claim 31 further including:
(c) transmitting Push-to-Talk commands of said interface from said communication application module to said communication device to terminate established Push-to-Talk communications for said mobile communication unit; and
(d) communicating information between said communication device and said Push-to-Talk server system to terminate said established Push-to-Talk communications within said communication system in response to said transmitted Push-to-Talk commands.

37. A method of enabling a communication application module of a mobile communication unit to control a communication device of that unit to perform Push-to-Talk communications within a communication system, wherein said mobile communication unit includes an interface between said communication application module and said communication device in the form of a compatible command set and said communication system includes a Push-to-Talk server system to control Push-to-Talk communications within said communication system, said method comprising:
(a) transmitting Push-to-Talk commands of said interface from said communication application module to said communication device to terminate established Push-to-Talk communications for said mobile communication unit; and
(b) communicating information between said communication device and said Push-to-Talk server system to terminate said established Push-to-Talk communications within said communication system in response to said transmitted Push-to-Talk commands.

38. The method of claim 37, wherein step (a) further includes:
(a.1) transmitting a Push-to-Talk session terminate command from said communication application module to said communication device to facilitate termination of an established Push-to-Talk session;
step (b) further includes:
(b.1) transmitting a termination message from said communication device to said Push-to-Talk server system to terminate said established Push-to-Talk session; and
(b.2) receiving an indication of a terminated session from said Push-to-Talk server system and transmitting an interface message from said communication device to said communication application module including information pertaining to said indication.

39. The method of claim 37, wherein step (a) further includes:
(a.1) transmitting Push-to-Talk commands of said interface from said communication application module to said communication device to facilitate Push-to-Talk communications for said mobile communication unit; and
(a.2) communicating information between said communication device and said Push-to-Talk server system to establish Push-to-Talk communications within said communication system in response to said transmitted Push-to-Talk commands.

40. The mobile communication unit of claim 1, wherein said communication application module includes a circuit card.

41. The mobile communication unit of claim 40, wherein said communication device includes a mobile terminal.

42. The mobile communication unit of claim 7, wherein said communication application means includes a circuit card.

43. The mobile communication unit of claim 42, wherein said communication means includes a mobile terminal.

44. The interface of claim 13, wherein said communication application module includes a circuit card.

45. The interface of claim 44, wherein said communication device includes a mobile terminal.

46. The apparatus of claim 19, wherein said communication application module includes a circuit card.

47. The apparatus of claim 46, wherein said communication device includes a mobile terminal.

48. The carrier signal of claim 25, wherein said communication application module includes a circuit card.

49. The carrier signal of claim 48, wherein said communication device includes a mobile terminal.

50. The method of claim 31, wherein said communication application module includes a circuit card.

51. The method of claim 50, wherein said communication device includes a mobile terminal.

52. The method of claim 37, wherein said communication application module includes a circuit card.

53. The method of claim 52, wherein said communication device includes a mobile terminal.
